(19) United States
(12) Patent Application Publication
(10) Pub. No.: US 2004/0019480 A1
(43) Pub. Date: Jan. 29, 2004

(54) Speech encoding device having TFO function and method

(76) Inventors: Teruyuki Sato, Kawasaki (JP); Yasutaka Kanayama, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/351,705

(22) Filed: Jan. 27, 2003

(30) Foreign Application Priority Data
Jul. 25, 2002 (JP) 2002-216937

(51) Int. Cl. G10L 19/00

(52) U.S. Cl. 704/201

(57) ABSTRACT

The internal state matching of an encoder when switching from TFO mode to tandem connection is maintained while suppressing the corresponding increase in the amount of processing. In the TFO mode, PCM data and compressed data transmitted in multiplexed form are demultiplexed by a PCM data/compressed data demultiplexing unit, and the compressed data is selected by a selector for output. At the same time, an encoding functional unit continues to encode the demultiplexed PCM data so that the internal state matching of the encoder can be maintained in case of a fallback to the tandem connection. At this time, to alleviate the processing burden of the encoder, part of the demultiplexed encoded data, for example, stochastic codebook data, is extracted and supplied to the encoding functional unit.

### BACKGROUND OF THE INVENTION

1. Field of the Invention

The present invention relates to a speech encoding device having a TFO function, and a method.

2. Description of the Related Art

In recent years, speech codecs that compress speech data for transmission have come to compress 64-kbps speech data in the telephone speech band to about 4 kbps to 8 kbps for transmission. In particular, in the field of mobile communications, low bit-rate speech codecs have come into use for efficient utilization of bandwidth. In such speech codecs, speech quality degradation due to the accumulation of distortion associated with compression and decompression, especially in the tandem operation of codecs (the configuration hereinafter called the tandem connection), has become a greater issue than before.

It is said that a method called digital one-link connection, in which data is transmitted end to end in compressed form as it is, is desirable for use with speech codecs. However, in mobile-to-mobile connections, for example, in the second generation mobile communication systems (such as European GSM, North American PCS, and Japan's PDC), a serial operation called a tandem connection, and not digital one-link connection, occurs. How this occurs will be explained with reference to FIG. 1. As a speech codec intervenes in order to connect a mobile unit 12 to a public network 10 in a mobile switching center (MLS) 14, the compressed data is once converted to 64 kbps PCM code even when the destination of the connection is a mobile unit 16. This results in a tandem connection in which the two speech codecs are connected in serial when connecting one mobile unit to the other, and causes degradation in speech quality.

A technique for solving this problem is disclosed in U.S. Pat. No. 5,991,716 or in 3GPP (3rd Generation Partnership Project) Technical Specification TS 28.062. This technique is called Tandem Free Operation (TFO) because the tandem connection of codecs is removed. An overview of this operation is shown in FIG. 2. By bit stealing from G.711 PCM data between TCs (Transcoders: codecs) 18 and 20 (the data is obtained by local decoding operations at the TCs), and by mapping compressed speech data thereon, the compressed data from the terminal is passed through without the TCs (codecs) themselves performing re-encoding (recompression) operations. This achieves a digital one-link between the mobile units. FIG. 3 shows the format of the data transmitted between the TCs. In this case, the six MSBs of the PCM data obtained by local decoding operations at the TCs are left unchanged, but the two LSBs are stolen and the compressed speech data bits are embedded therein.

The feature of the above TFO method is that both the PCM data and the compressed speech data are transmitted by multiplexing them together, not transmitting the compressed speech data instead of the PCM data. This enables the speech signal to be transmitted end to end via a digital one-link connection to the remote end even when the remote end is a mobile unit.

In mobile communications, handover occurs as a mobile terminal moves. As shown in FIG. 4, during communication via a TFO connection established between TC 22 and TC 24 that support TFO, for example, if the mobile terminal 28 moves and a handover occurs from the TC 24 to a TFO non-supporting TC 26, the TFO has to be interrupted. To provide for such cases, the TC 22 must also be-provided with a means for allowing a fallback from the TFO to the tandem connection, that is, a function for encoding PCM data, received from the TC 26, into compressed speech data so that switching can be made from the compressed data pass-through mode to the encoding mode in the event of a fallback to the tandem connection. Such means is also needed so that, in the event of an increased error rate between the TCs, switching can be made at the receiving TC so as to use PCM data less affected by error. However, the following problem occurs when effecting a fallback to the tandem connection.

In recent codecs, prediction schemes have become an essential technology for achieving a high compression ratio, and it is practiced to predict the present signal from the past received signal by making use of its statistical nature, and to encode only the prediction residual. This prediction works well, provided that the internal state variables are matched between the encoder and decoder. In fact, when a reset is performed during encoding and the resulting compressed speech data is processed by the decoder which is not reset, it can be confirmed that a signal of maximum amplitude may be reproduced in certain cases (conversely, resetting only the decoder will not cause a significant effect on signal reproduction, since the decoder has the robustness that allows reproduction from any point in the encoded data).

As shown in FIG. 5, during the TFO operation in which the compressed speech data is allowed to pass through, the encoder of the receiving TC 22 is not operating, so that its internal state is in a floating state. When a fallback to the tandem connection occurs, the encoder of the TC 22 is switched in, and this can cause a problem such as described above in the decoder contained in the mobile unit 30.

One possible method to avoid this problem is to continue encoding, at the TC 22, the speech decoded by the right-hand side TC 26 and thereby to prevent the occurrence of a state mismatch. In another possible method, the encoder is not kept operating at all times, but when it is detected by a suitable means that a tandem fallback should be effected, the encoder starts to operate (while stopping the transmission of the encoded data for a certain period of time) before switching is made to the tandem connection.

However, these methods require that the encoding which involves a large amount of computation be performed during the TFO operation and, therefore, this defeat the purpose of reducing the amount of processing which is a feature of TFO. If the encoder is operated only when necessary, this is no different from operating the encoder at all times, if the worst case is considered, and this also defeats the purpose of reducing the amount of processing.

### SUMMARY OF THE INVENTION

The present invention has been devised to solve the above problem in a speech encoder having a TFO function, and an object of the invention is to provide a speech encoding device and method that can maintain internal state matching, while suppressing an increase in the amount of processing, to provide for the case of a fallback to the tandem connection.

According to the present invention, there is provided a speech encoding device comprising: means for receiving non-compressed speech data and first compressed speech data which correspond to the non-compressed speech data and which are generated through compression coding; an encoder for generating second compressed speech data from the non-compressed speech data in a first operation mode; simplified encoding means for supplying part of the first compressed speech data to the encoder and thereby causing the encoder to perform simplified encoding in a second operation mode; and a selector for selecting the first compressed speech data for output in the second operation mode, and for selecting the second compressed speech data for output in the first operation mode.

Preferably, the encoder generates the compressed speech data by code excited linear predictive coding, and the simplified encoding means supplies stochastic code data to the encoder as that part of the compressed speech data.

### BRIEF DESCRIPTION OF THE DRAWINGS

FIG. 1 is a diagram for explaining a tandem connection of speech codecs;

FIG. 2 is a diagram for explaining TFO;

FIG. 3 is a diagram showing the format of data transmitted between TCs in TFO;

FIG. 4 is a diagram for explaining a fallback to the tandem connection;

FIG. 5 is a diagram for explaining a problem occurring when a fallback to the tandem connection occurs;

FIG. 6 is a block diagram of a speech encoding device based on CELP;

FIG. 7 is a block diagram of a speech encoding device according to one embodiment of the present invention;

FIG. 8 is a diagram for explaining a time difference between a codec processing unit frame and transmitted data;

FIG. 9 is a diagram for explaining how time difference information is extracted;

FIG. 10 is a block diagram showing one example of a configuration for accomplishing the extraction of the time difference information and the buffering control performed based on the extracted information;

FIG. 11 is a diagram for explaining how the amount of delay can be reduced;

FIG. 12 is a diagram for explaining the reconstruction of a stochastic signal; and

FIG. 13 is a diagram for explaining an example of buffering in an ACELP-based codec.

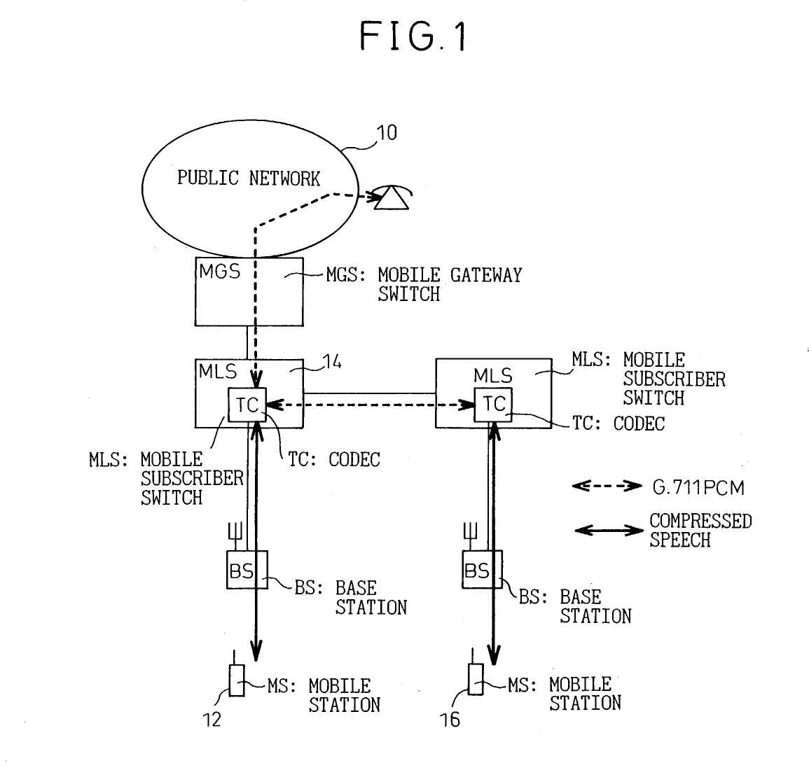

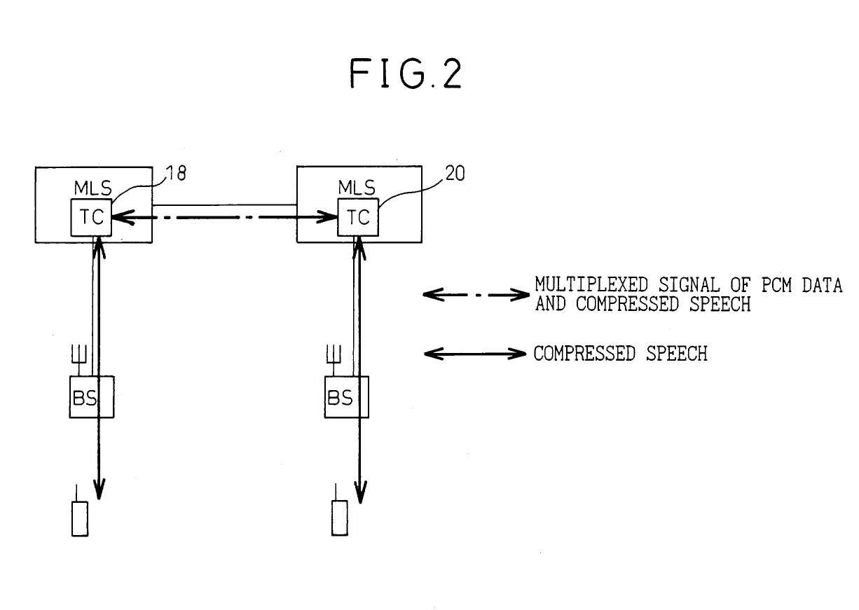

### DESCRIPTION OF THE PREFERRED EMBODIMENTS

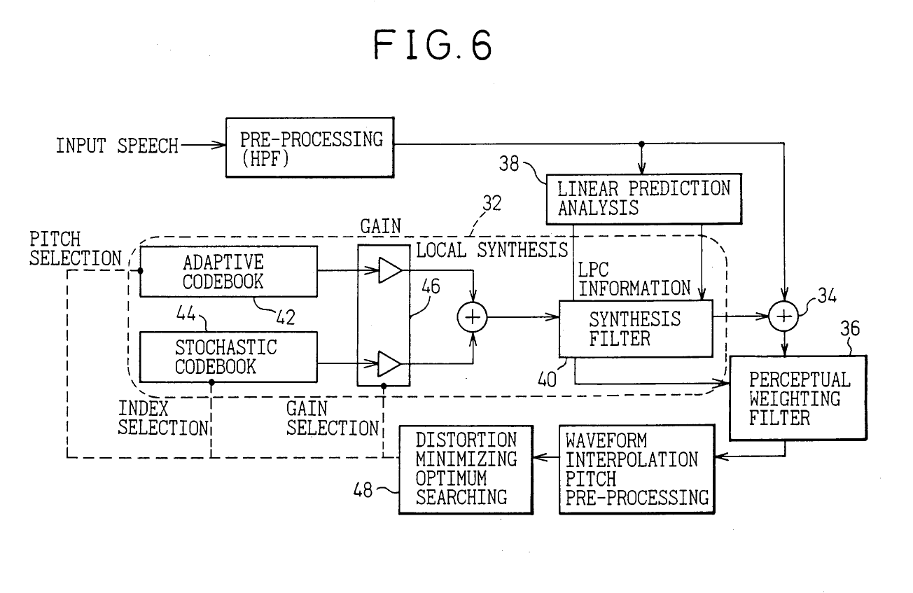

FIG. 6 shows the configuration of a speech encoding device based on CELP (Code Excited Linear Prediction). As is well known, in the speech encoding device such as CELP that uses vector quantization, an output of a local synthesis part (decoder) 32 and an input speech vector are added in an adder 34 to compute the error between them, and parameters to be applied to the local synthesis part 32 are determined such that the result of the perceptual weighting applied by a perceptual weighting filter 36 becomes the smallest, the parameters thus determined being the results of the encoding. At the decoding side, the same computations as performed in the local synthesis part 32 are performed by using the above parameters to reconstruct a speech signal close to the input speech.

In the present invention, in the TFO (Tandem Free Operation) mode also, that is, in the operation mode in which the compressed speech data, demultiplexed from the multiplexed signal carrying the PCM data and the compressed speech data, is passed unchanged, the encoder keeps on encoding and compressing the PCM data demultiplexed from the multiplexed signal, thereby maintaining the internal state of the encoder close to that of the encoder that produced the compressed speech data and thus providing for a fallback to the tandem connection; at the same time, to alleviate the burden of the encoder, part of the compressed speech data demultiplexed from the multiplexed signal is used as part of the parameters necessary for the local synthesis 32 performed within the encoder.

The parameters necessary for the local synthesis include: a filter coefficient for an LPC synthesis filter 40, which is obtained by a linear prediction analysis 38 of the input speech; the value of pitch to be supplied to an adaptive codebook 42 which reproduces a voiced sound; an index value to be supplied to a stochastic codebook 44 which reproduces an unvoiced sound; and the gain of the voiced and unvoiced sounds to be supplied to a gain element 46. Any of these parameters may be derived from the compressed speech signal demultiplexed from the multiplexed signal; here, the output of stochastic codebook 44 is a component signal to which prediction cannot be applied, and there is no other way but to search for its index value by using a heuristic algorithm and, besides, there is no stored value as a state variable. Deriving this parameter from the compressed speech signal is therefore the simplest and its effectiveness is the greatest of all of the above parameters. More specifically, when deriving the index value for the stochastic codebook 44 from the data demultiplexed from the multiplexed signal, it is only necessary to switch to that data, and this eliminates the need for searching for the index value by using the heuristic algorithm in a distortion minimizing optimum searching unit 48.

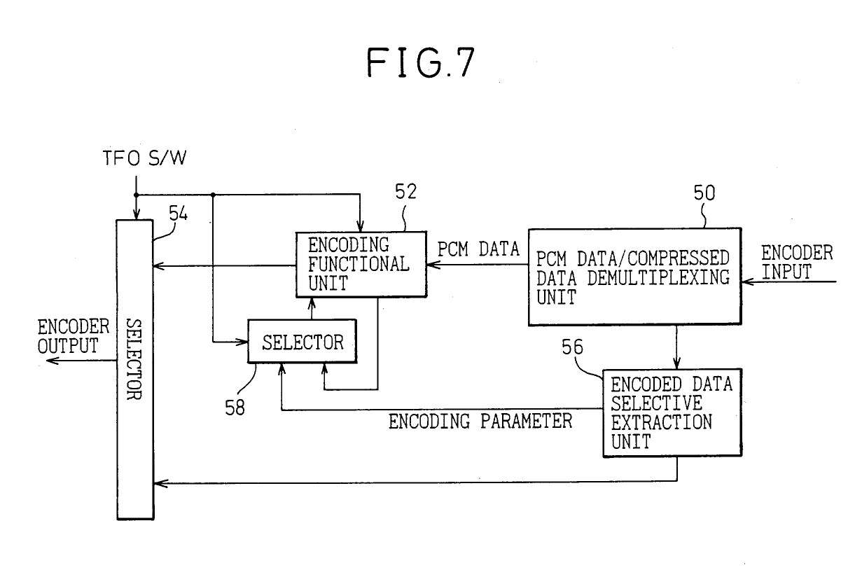

FIG. 7 shows the configuration of one embodiment of a speech encoding device based on the above concept according to the present invention.

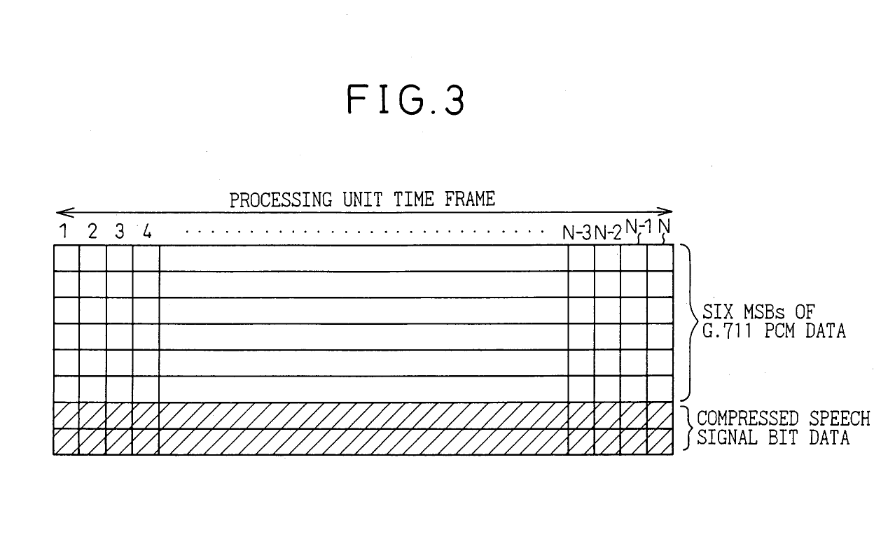

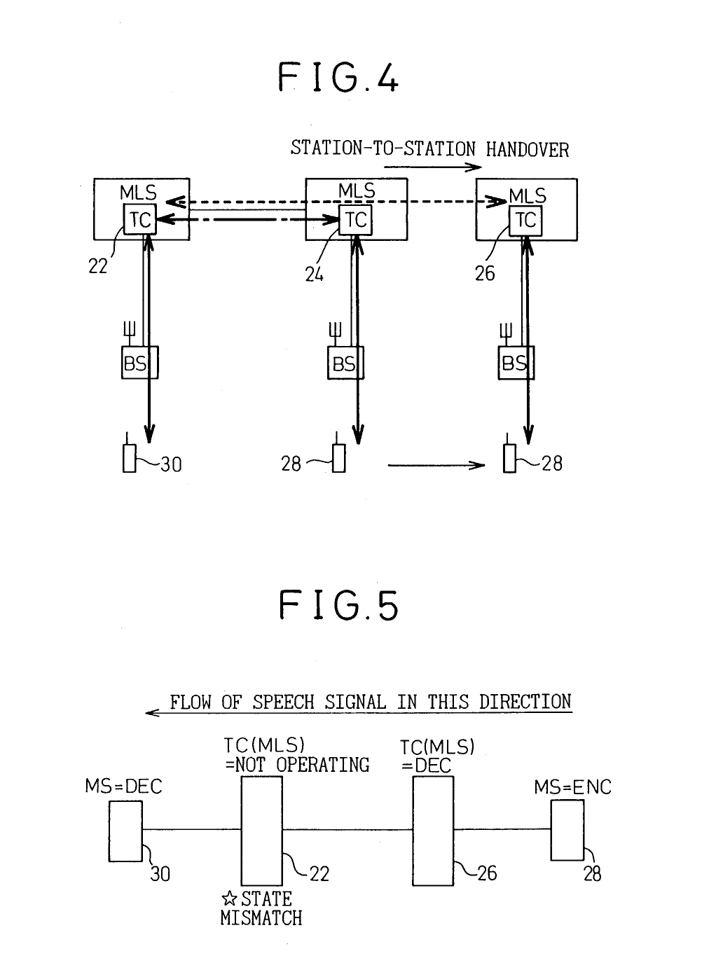

The input signal to the encoding device is of the format shown in FIG. 3 and contains the PCM data decoded at the remote-end TC and the compression-encoded data passed unchanged through the remote-end TC. A PCM data/compressed data demultiplexing unit 50 demultiplexes these two kinds of signals. The demultiplexed PCM data is again encoded and compressed by an encoding functional unit 52 contained in the encoding device. In the event of a fallback to the tandem connection, the output of the encoding functional unit 52 is selected by a selector 54 for output.

On the other hand, during TFO, the demultiplexed compression-encoded data is selected by the selector 54 for output; at this time, part of the data, for example, the index for the stochastic codebook, is extracted by an encoded data selective extraction unit 56. The extracted encoded data is selected by a selector 58 and supplied to the encoding functional unit 52. As a result, during TFO, the encoding functional unit 52 is spared the necessity of performing part of the process, for example, searching for the index value.

When a fallback to the tandem connection occurs, the usual encoding process including a search for the index value is performed. Here, instead of supplying the codebook index to the encoding functional unit 52 during TFO, stochastic code reconstructed from data carrying the feature of the stochastic code may be supplied as will be described later.

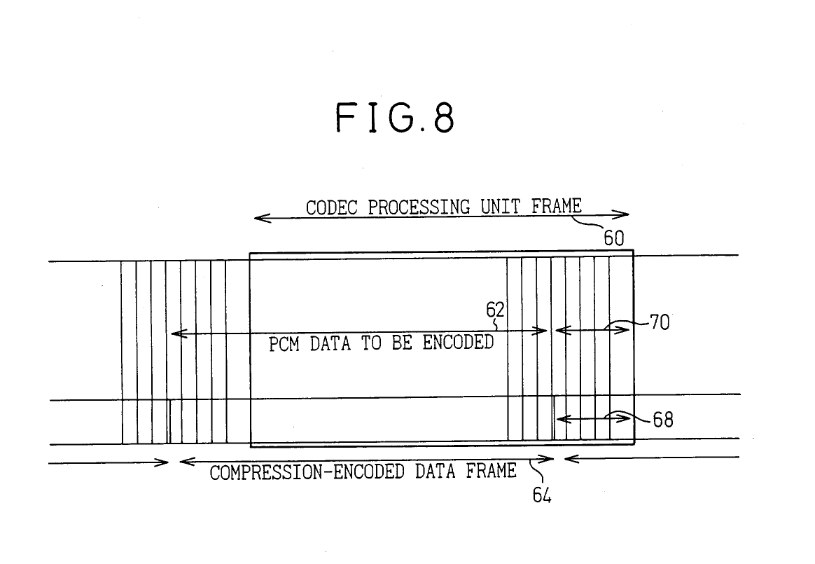

As shown in FIG. 8, the phase of the encoding operation in the encoding functional unit 52 (the phase of the processing unit frame 60) does not generally match the phase of the PCM data 62 or the compression-encoded data frame 64 in the multiplexed signal.

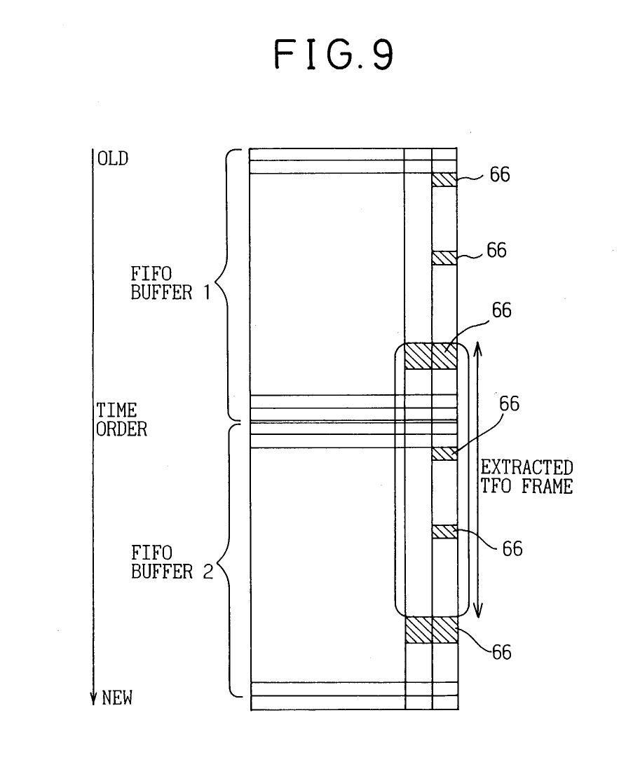

As shown in FIG. 9, synchronization patterns 66 are appended to the compressed data embedded in the PCM data. Therefore, a FIFO buffer whose length is twice the length of the codec processing unit frame is provided, as shown in FIG. 9, and a compressed data frame is extracted by scanning through the data for the synchronization patterns. The difference between the boundary of the frame thus extracted and the codec processing unit frame is extracted as time difference information 68 (FIG. 8). In FIG. 8, the trailing end portion of the compression-encoded data remaining to be transmitted after the end of the processing unit frame 60 is stored in the buffer for use in the processing of the next frame. Likewise, as the PCM data also needs to be matched in phase by extracting time difference information 70, the portion corresponding to the time difference is stored in the buffer.

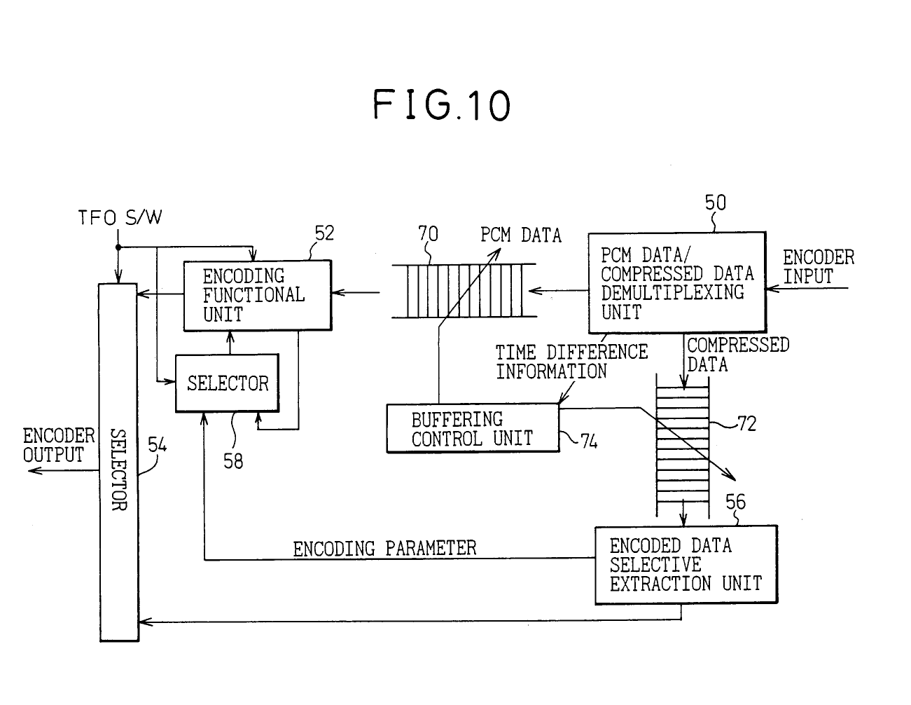

FIG. 10 shows an example of how this is accomplished. The PCM data and the compressed data demultiplexed by the PCM data/compressed data demultiplexing unit 50 are stored in buffers 70 and 72, respectively. A buffering control unit 74 extracts the respective time information, and controls the storing and retrieval operations to the respective buffers 70 and 72.

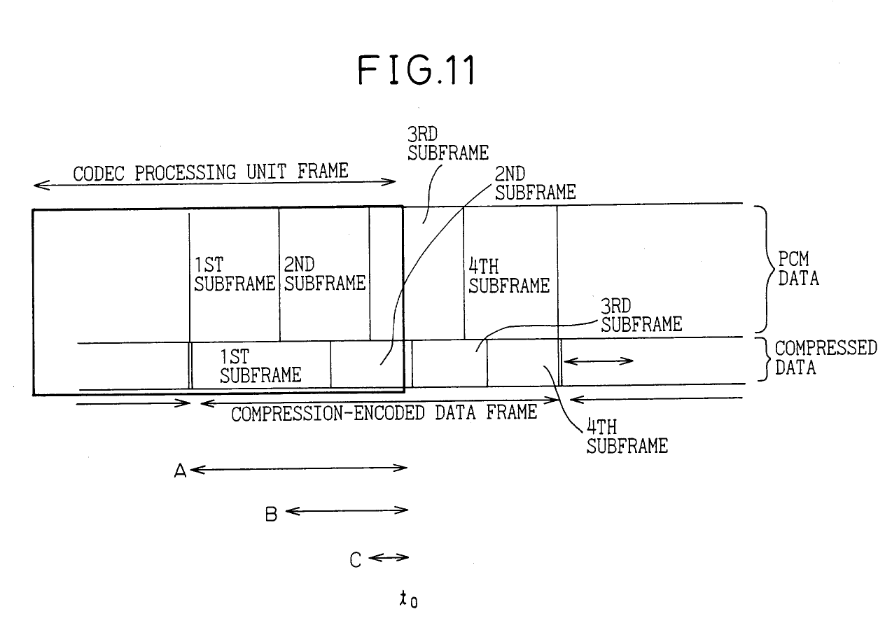

Since the frame boundary and the codec processing unit frame do not generally coincide with each other, a processing delay equivalent to one codec processing unit frame could result, in the worst case. On the other hand, the codec usually has a processing unit called the subframe smaller than the processing unit frame. When the buffering control is performed using the subframe as a unit, the processing delay can be reduced. This will be explained with reference to FIG. 11 by assuming that the processing unit frame length is 20 ms and the subframe length is 5 ms.

In the frame-by-frame buffering control so far described, the data in the area indicated by A in FIG. 11 are held in the respective buffers at time t₀ which indicates the end of one processing unit frame; therefore, the amount of delay is equal to A. According to TS 28.062, for example, the compressed data frame is also divided into units of subframes; here, if data arrival is detected on a subframe-by-subframe basis, not only the PCM data but the compressed data can also be matched in phase on a subframe-by-subframe basis, eliminating the need for matching the phase for the entire frame, and the amount of delay can thus be reduced. In FIG. 11, as the first subframe data is already received at time t₀, this data is not buffered but is used for processing. As a result, the amount of delay can be reduced to B.

Further, the codec has a delay called the algorithm delay; this delay is 5 ms, for example, in the case of the AMR, the standard codec in the third generation mobile communications. This is implemented as a read-ahead buffer in the encoding device, meaning that 5 ms of read-ahead is possible. That is, in FIG. 11, at time t₀ the second subframe of the compressed data has not arrived yet, but the second subframe of the PCM data can be processed for encoding; as a result, the amount of delay can be reduced to C.

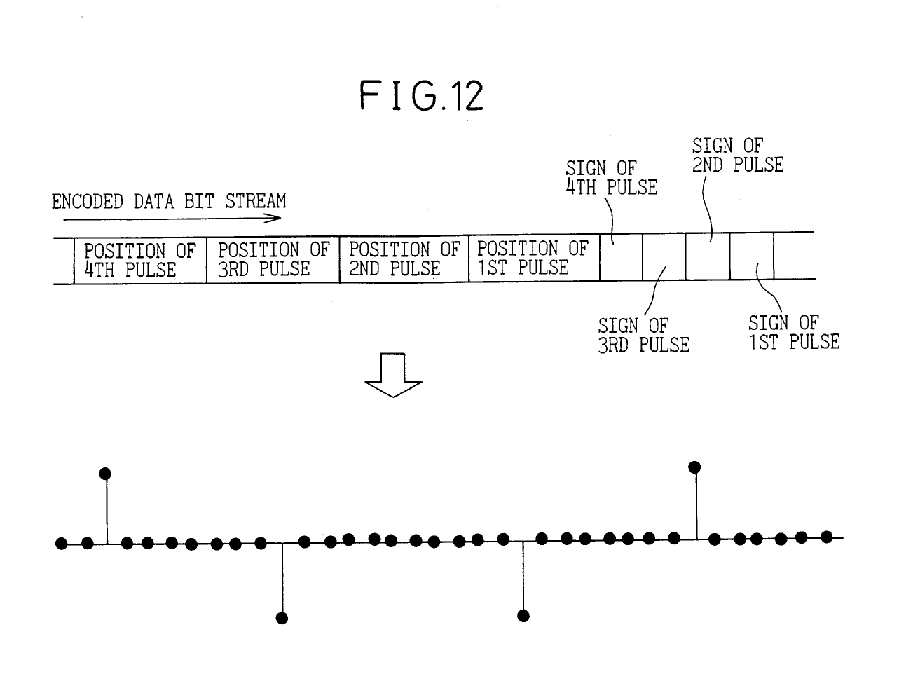

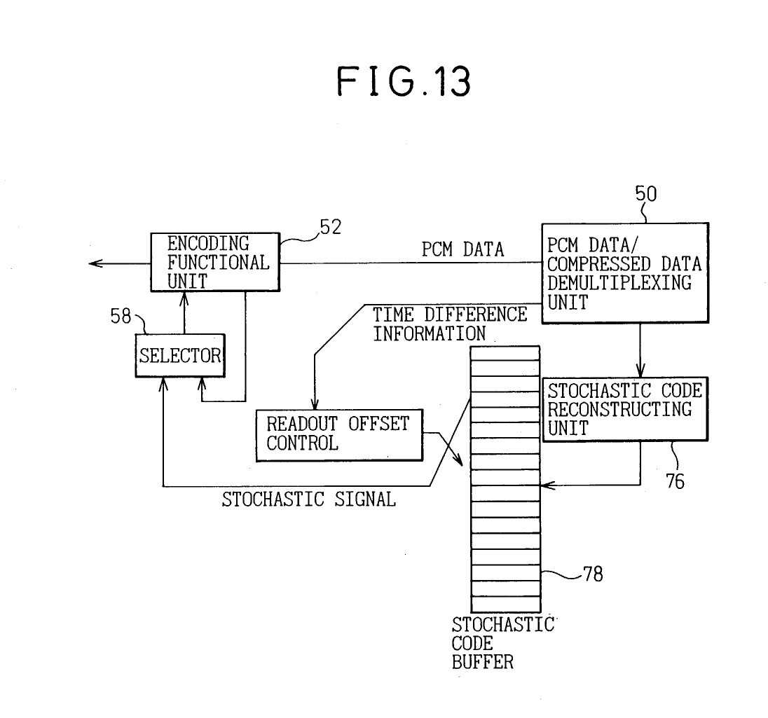

In the case of an ACELP (Algebraic Code Excited Linear Prediction) codec, which is a class of CELP codecs, data indicating the positions and signs of the pulses forming a stochastic signal is transmitted as stochastic codebook data, as shown in FIG. 12. Then, as shown in FIG. 13, the stochastic signal is reconstructed by a stochastic code reconstructing unit 76, and the reconstructed data is stored in a buffer 78.

As described above, according to the present invention, the internal state matching of the encoder when switching from the TFO mode to the tandem connection can be maintained while suppressing the corresponding increase in the amount of processing.

1. A speech encoding device comprising:
means for receiving non-compressed speech data and first compressed speech data which correspond to the non-compressed speech data and which are generated through compression coding;
an encoder for generating second compressed speech data from said non-compressed speech data in a first operation mode;
simplified encoding means for supplying part of said first compressed speech data to said encoder and thereby causing said encoder to perform simplified encoding in a second operation mode; and
a selector for selecting said first compressed speech data for output in said second operation mode, and for selecting said second compressed speech data for output in said first operation mode.

2. A speech encoding device according to claim 1, wherein said encoder generates said second compressed speech data by code excited linear predictive coding, and
said simplified encoding means supplies stochastic code data to said encoder as said part of said compressed speech data.

3. A speech encoding device according to claim 1 or 2, wherein said first compressed speech data is received in the form of a multiplexed signal multiplexed on said non-compressed speech data, and
said speech encoding device further comprises means for demultiplexing said non-compressed speech data and said first compressed speech data from said multiplexed signal.

4. A speech encoding device according to claim 3, further comprising means for buffering said first compressed speech data and said non-compressed speech data, respectively, and wherein
time difference information of said first compressed speech data and said non-compressed speech data with respect to a processing phase of said encoder is extracted during said demultiplexing, and
based on said time difference information, said first compressed speech data and said non-compressed speech data are retrieved from said buffering means.

5. A speech encoding device according to claim 4, wherein reconstructed stochastic code data is buffered as the part of compressed speech data.

6. A speech encoding method comprising the steps of:
receiving non-compressed speech data and first compressed speech data which correspond to the non-compressed speech data and which are generated through compression coding;
generating in an encoder second compressed speech data from said non-compressed speech data in a first operation mode;
supplying part of said first compressed speech data to said encoder and thereby causing said encoder to perform simplified encoding in a second operation mode; and
selecting said first compressed speech data for output in said second operation mode, and selecting said second compressed speech data for output in said first operation mode.

7. A speech encoding method according to claim 6, wherein said encoder generates said second compressed speech data by code excited linear predictive coding, and
in said second operation mode, stochastic code data is supplied to said encoder as said part of said compressed speech data.
